(19) United States
(12) Patent Application Publication
(10) Pub. No.: US 2023/0129467 A1
(43) Pub. Date: Apr. 27, 2023

(54) SYSTEMS AND METHODS TO ANALYZE AUDIO DATA TO IDENTIFY DIFFERENT SPEAKERS

(71) Applicant: Citrix Systems, Inc., Fort Lauderdale, FL (US)

(72) Inventor: Manbinder Pal Singh, Coral Springs, FL (US)

(21) Appl. No.: 17/508,212

(22) Filed: Oct. 22, 2021

(51) Int. Cl. G10L 17/02; G10L 17/14; G10L 25/87; G10L 15/02

(52) U.S. Cl. CPC G10L 17/02; G10L 17/14; G10L 25/87; G10L 15/02

(57) ABSTRACT

A computing system may receive data representing dialog between persons, the data representing words spoken by at least first and second speakers, determine an intent of a speaker for a first portion of the data, the intent being indicative of an identity of the first or second speaker for the first portion of the data or another portion of the data different than the first portion, determine a name of the first or second speaker represented in the first portion of the data based at least in part on the determined intent, and output an indication of the determined name so that the indication identifies the first portion of the data or the another portion of the data with the first or second speaker.

### BACKGROUND

Various file sharing systems have been developed that allow users to share files or other data. ShareFile®, offered by Citrix Systems, Inc., of Fort Lauderdale, Fla., is one example of such a file sharing system.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method involves receiving, by a computing system, data representing dialog between persons, the data representing words spoken by at least first and second speakers, determining, by the computing system, an intent of a speaker for a first portion of the data, the intent being indicative of an identity of the first or second speaker for the first portion of the data or another portion of the data different than the first portion, determining, by the computing system, a name of the first or second speaker represented in the first portion of the data based at least in part on the determined intent, and outputting, by the computing system, an indication of the determined name so that the indication identifies the first portion of the data or the another portion of the data with the first or second speaker.

In some disclosed embodiments, a computing system may comprise at least one processor at least one computer-readable medium encoded with instructions which, when executed by the at least one processor, cause the computing system to receive data representing dialog between persons, the data representing words spoken by at least first and second speakers, the intent being indicative of an identity of the first or second speaker for the first portion of the data or another portion of the data different than the first portion, determine an intent of a speaker for a first portion of the data, determine a name of the first or second speaker represented in the first portion of the data based at least in part on the determined intent, and output an indication of the determined name so that the indication identifies the first portion of the data or the another portion of the data with the first or second speaker.

In some disclose embodiments, at least one non-transitory computer-readable medium may be encoded with instructions which, when executed by at least one processor of a computing system, cause the computing system to receive data representing dialog between persons, the data representing words spoken by at least first and second speakers, determine an intent of a speaker for a first portion of the data, the intent being indicative of an identity of the first or second speaker for the first portion of the data or another portion of the data different than the first portion, determine a name of the first or second speaker represented in the first portion of the data based at least in part on the determined intent, and output an indication of the determined name so that the indication identifies the first portion of the data or the another portion of the data with the first or second speaker.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A is a diagram of how a system may determine a speaker name from data representing words spoken by at least two speakers, in accordance with some aspects of the present disclosure;

FIG. 1B shows various example words spoken by a first speaker and a second speaker;

FIG. 1C shows example speaker names that may be determined based on processing the example words shown in FIG. 1B;

FIG. 2 is a diagram of a network environment in which some embodiments of the present disclosure may be deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a diagram illustrating how a network computing environment like one shown in FIG. 2 may be configured to allow clients access to an example embodiment of a file sharing system;

FIG. 5B is a diagram illustrating certain operations that may be performed by the file sharing system shown in FIG. 5A in accordance with some embodiments;

FIG. 5C is a diagram illustrating additional operations that may be performed by the file sharing system shown in FIG. 5A in accordance with some embodiments;

FIG. 6A illustrates an example implementation of a speaker name identification system, in accordance with some embodiments;

FIG. 6B shows example data that may be processed by the speaker name identification system 100, in accordance with some embodiments;

FIG. 7 shows a first example routine that may be performed by the speaker name identification system shown in FIG. 6A in accordance with some embodiments;

FIG. 8 shows a second example routine that may be performed by the speaker name identification system shown in FIG. 6A in accordance with some embodiments;

FIG. 9 shows a third example routine that may be performed by the speaker name identification system shown in FIG. 6A in accordance with some embodiments; and

FIG. 10 shows a fourth example routine that may be performed by the speaker name identification system shown in FIG. 6A in accordance with some embodiments.

### DETAILED DESCRIPTION

Audio recordings of persons speaking, for example, during a meeting, a presentation, a conference, etc., are useful in memorializing what was said. Often such audio recordings are converted into a transcript, which may be a textual representation of what was said. Some systems, such as virtual meeting applications, are configured to identify which words are spoken by which speaker based on each individual speaker participating in the meeting using his/her own device. Such systems typically identify an audio stream from a device associated with a speaker, determine a speaker name as provided by the speaker when joining the meeting, and assign the speaker name to the words represented in the audio stream.

The inventor of the present disclosure has recognized and appreciated that there is a need to identify speaker names for an audio recording that does not involve individual speakers using their own devices. In such cases, audio of multiple persons speaking may be recorded using a single device (e.g., an audio recorder, a smart phone, a laptop, etc.), and may not involve separate audio streams that can be used to identify which words are spoken by which speaker. Existing systems may provide speaker diarization techniques that process an audio recording, generate a transcript of the words spoken by multiple persons, and identify words spoken by different persons using generic labels (e.g., speaker A, speaker B, etc. or, speaker 1, speaker 2, etc., or first speaker, second speaker, etc.). Such existing speaker diarization techniques may only use differences in the audio data to determine when a different person is speaking, and can, thus, only assign the person a generic speaker label. Using only the differences in the audio data, existing speaker diarization techniques are not able to identify a speaker's name. The inventor of the present disclosure has recognized and appreciated that generic speaker labels are not as useful as knowing the speaker name. Generic speaker labels may make it difficult for a user/reader to fully understand a transcript, and may require the user/reader to manually keep track of the actual speaker's name (assuming that the user/reader knows the speaker's name) for each generic speaker label. As such, offered are techniques for identifying speaker names from data (e.g., a transcript) representing words spoken by multiple persons.

Some implementations involve determining a meaning (e.g., an intent) of a portion of the words (e.g., a sentence spoken by a first person), and determining a person name included in the portion of the words. The meaning of the words may be what the speaker of the words meant to convey/say, and the meaning of the words may be represented as an intent or as a speaker's intent. Based on the determined intent and the person name, some implementations involve determining the person name as being the name of one of the speakers. Some implementations involve outputting an indication of the speaker name and associating the indication, for example in a transcript, with the words spoken by that speaker. Identifying the speaker name may be beneficial to a user, for example, in identifying what was said by a particular person, in searching for words said by a particular person, or even in just reading/understanding what was said (it may be easier to understand a discussion/conversation if the user knows the speaker names, rather than tracking generic speaker labels).

The techniques of the present disclosure may be used to identify speaker names for various types of recorded events, such as a meeting, a conference involving a panel of speakers, a telephone or web conference, etc. The techniques of the present disclosure may also be used to identify speaker names from live audio/video streams, rather than recorded audio/video, as the audio/video input is captured/received by the device/system. The techniques of the present disclosure may also be used to identify speaker names for certain types of media that involve dialog exchanges, such as a movie, a TV show, a radio show, a podcast, a news interview, etc.

For purposes of reading the description of the various embodiments below, the following descriptions of the sections of the specification and their respective contents may be helpful:

Section A provides an introduction to example embodiments of a speaker name identification system;

Section B describes a network environment which may be useful for practicing embodiments described herein;

Section C describes a computing system which may be useful for practicing embodiments described herein.

Section D describes embodiments of systems and methods for delivering shared resources using a cloud computing environment;

Section E describes example embodiments of systems for providing file sharing over networks;

Section F provides a more detailed description of example embodiments of the speaker name identification system introduced in Section A; and

Section G describes example implementations of methods, systems/devices, and computer-readable media in accordance with the present disclosure.

### A. Introduction to Illustrative Embodiments of a Speaker Name Identification System

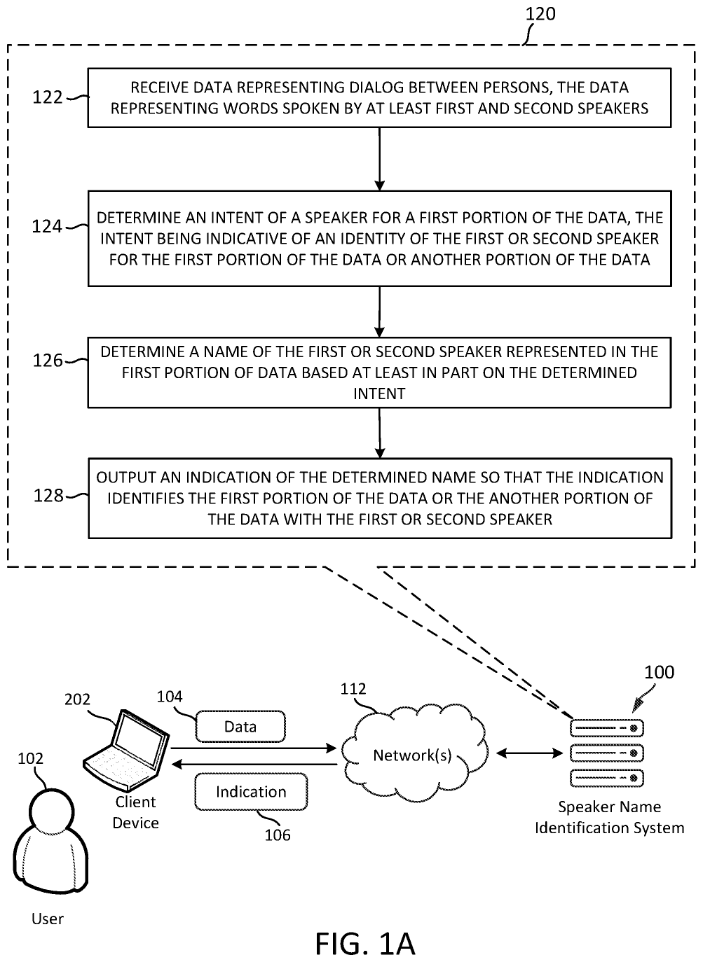

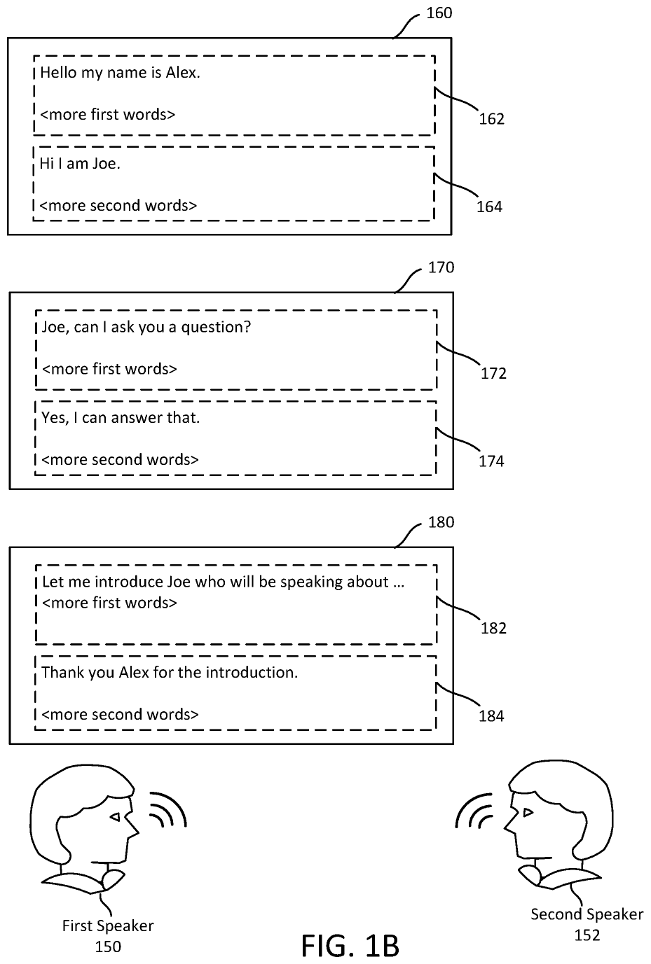

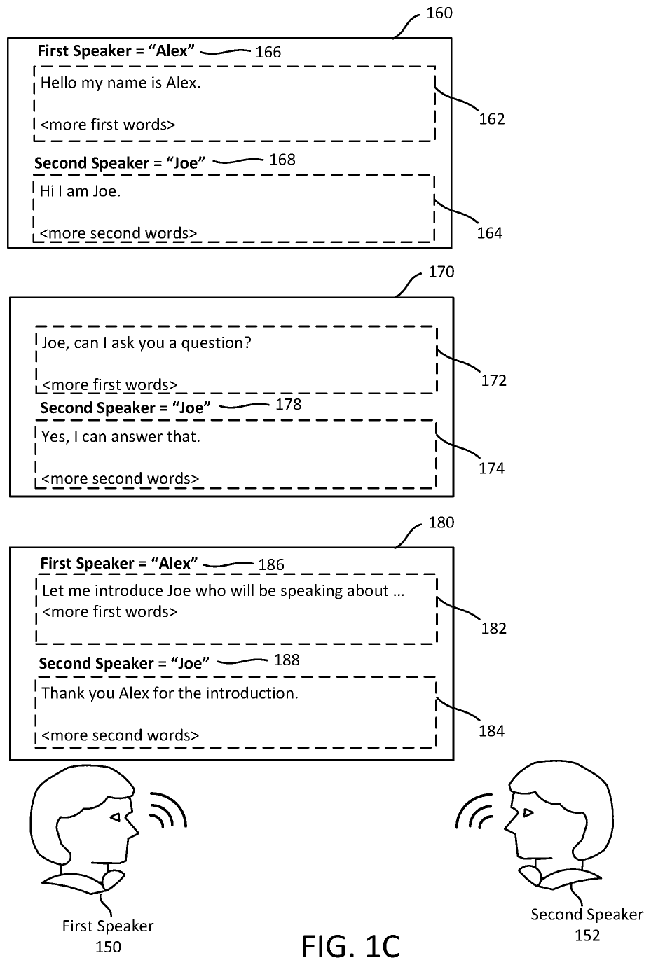

FIG. 1A illustrates how a system (e.g., a speaker name identification system 100) may determine a speaker name from data representing words spoken by at least two speakers. As shown in FIG. 1A, a client device 202, operated by a user 102, may be in communication with the speaker name identification system 100 using one or more networks 112. An example routine 120 that may be performed by the speaker name identification system 100 is illustrated in FIG. 1A.

As shown in FIG. 1A, the user 102, via the client device 202, may provide data 104, which may represent words spoken by multiple persons. In some implementations, the data 104 may correspond to an audio file (or a video file) capturing words spoken by multiple persons. The data 104 may not include individual speaker's identities/names. For example, the user 102 may select a file already stored at the client device 202, or may store a file at the client device 202. In some implementations, the client device 202 may process the file using a speech recognition technique to determine the data 104, which may be text data representing the words spoken by the persons. In other implementations, the client device 202 may process the file, or cause the file to be processed by a remote computing system, using a speaker diarization technique to identify from the data 104, which text data representing words spoken by the persons, and may additionally include a generic speaker label (e.g., speaker A, speaker B, etc. or speaker 1, speaker 2, etc.) identifying words that are spoken by different persons.

In other implementations, the user 102 may send, via the client device 202, the audio (or video) file/data to the speaker name identification system 100 for processing. In such implementations, the speaker name identification system 100 may process the file using a speech recognition technique and/or a speaker diarization technique to determine the data 104 representing words spoken by persons.

In any event, at a step 122, the speaker name identification system 100 may receive the data 104 representing dialog between persons, the data 104 representing words spoken by at least first and second speakers. The data 104 from an audio (or a video) file capturing or otherwise including the words. The data 104 may be text data or other type of data representing the first and second words. For example, the data 104 may be tokenized representations (e.g., sub-words) of the first and second words. In some implementations, the data 104 may be stored as a text-based file. In some implementations, the data 104 may be synchronized with the corresponding audio (or video) file, if one is provided by the user 102. In some implementations, the data 104 may identify first words (e.g., one or more sentences) spoken by the first speaker and second words (e.g., one or more sentences) spoken by the second speaker.

At a step 124 of the routine 120, the speaker name identification system 100 may determine an intent of a speaker for a first portion of the data 104, where the intent is indicative of an identity of the first or second speaker for the first portion of the data 104 or another portion of the data 104. The first portion of the data 104 may represent multiple words (e.g., one or more sentences) spoken by the first speaker or the second speaker. As such, the first portion of the data 104 may be a subset of the first words or a subset of the second words. In some cases, the first portion of the data 104 may include words spoken by the first speaker and the second speaker. As such, the first portion of the data 104 may be a subset of the first words and a subset of the second words. The speaker name identification system 100 may use one or more natural language processing (NLP) techniques to determine a meaning/intent of the speaker for the first portion of the data 104. The NLP techniques may be configured to identify certain intents relevant for identifying a speaker name. For example, in some implementations, the NLP techniques may be configured to identify a self-introduction intent, an intent to introduce another person, and/or a question intent.

At a step 126, the speaker name identification system 100 may determine a name of the first or second speaker represented in the first portion of the data 104 based at least in part on the determined intent. The speaker name identification system 100 may use NLP techniques, such as named entity recognition (NER) technique, to determine the name from the first portion of the data 104 (e.g., a subset of the first words and/or a subset of the second words). In some implementations, the NER technique may be configured to identify person names (e.g., first name, last name, or first and last name).

The speaker name identification system 100 may determine the name of a speaker based at least in part on the speaker's intent (determined in the step 124). For example, the speaker's intent, associated with a sentence spoken by the first speaker, may be a self-introduction intent, and the sentence may include a person name. In this example, the person name may be determined to be the first speaker's name based on the speaker's intent being a self-introduction. As another example, the speaker's intent, associated with a first sentence spoken by the second speaker, may be an intent to introduce another person, and the first sentence may include a person name. The first sentence may be followed by a second sentence spoken by the first speaker. In this example, the person name (included in the first sentence) may be determined to be the first speaker's name based on the intent associated with the first sentence being an intent to introduce another person. As yet another example, the speaker's intent associated with a first sentence, spoken by the second speaker, may be a question intent, and the first sentence may include a person name. The first sentence may be followed by a second sentence spoken by the first speaker. In this example, the person name (included in the first sentence) may be determined to be the first speaker's name based on the intent associated with the first sentence being a question intent. In some implementations, the speaker name identification system 100 may employ a rules-based engine, a machine learning (ML) model, and/or other techniques to determine that the name is the first or second speaker name based on the particular speaker's intent. The rules-based engine and/or the ML model may be configured to recognize the foregoing examples, and to determine the first speaker name accordingly. The rules-based engine and/or the ML model may be configured to recognize other additional scenarios (e.g., where, within a conversation, a speaker name may be provided/spoken based on the speaker's intent).

At a step 128, the speaker name identification system 100 may output an indication 106 of the determined name so that the indication identifies the first portion of the data 104 or the another portion of the data 104 with the first or second speaker. The indication 106 may be text representing that the portion of the data 104 (e.g., some words/sentences) are spoken by the first speaker or the second speaker. In some implementations, the speaker name identification system 100 may insert the indication 106 in the transcript included in the data 104. For example, the speaker name identification system 100 may insert text, representing the name, in the transcript, and may associate the text with the words (e.g., first words) spoken by the first speaker or with the words (e.g., second words) spoken by the second speaker. In some implementations, the speaker name identification system 100 may insert the indication 106 in the audio (or video) file, if provided by the user 102, to indicate the words spoken by the first or second speaker. For example, the speaker name identification system 100 may insert markers, in the audio file, to tag portions of the audio corresponding to the first words spoken by the first speaker. As another example, the speaker name identification system 100 may insert text or graphics in the video file, such that playback of the video file results in display of the name of the first speaker when the first words are played.

FIG. 1B shows various example words spoken by a first speaker 150 and a second speaker 152. Such example words may be represented in the data 104. FIG. 1B shows three example conversations 160, 170 and 180. The first example conversation 160 may include first words 162 spoken by the first speaker 150 and second words 164 spoken by the second speaker 152. As shown, the first words 162 may include “Hello my name is Alex”, and the second words 164 may include “Hi I am Joe.” The second example conversation 170 may include first words 172 spoken by the first speaker 150 and second words 174 spoken by the second speaker 152. As shown, the first words 172 may include “Joe, can I ask you a question”, and the second words 174 may include “Yes, I can answer that.” The third example conversation 180 may include first words 182 spoken by the first speaker 150 and second words 184 spoken by the second speaker 152. As shown, the first words 182 may include “Let me introduce Joe who will be speaking about . . . ”, and the second words 184 may include “Thank you Alex for the introduction.” As illustrated, the data 104 may identify first words spoken by a first speaker and second words spoken by a second speaker, but may not identify (e.g., by name) who the first and second speakers are.

FIG. 1C shows example outputs that may be determined by the speaker name identification system 100 based on processing the example conversations shown in FIG. 1B. As discussed in relation to FIG. 1A, the speaker name identification system 100 may determine a speaker's intent associated with a first portion of the data 104 and may determine a name represented in the first portion of the data 104. For the first example conversation 160, the first portion of the data 104 may be the first words 162 including “Hello my name is Alex”. The speaker name identification system 100 may determine the speaker's intent to be a self-introduction intent, and may determine “Alex” is a name represented in the first words 162. Based on the self-introduction intent, the speaker name identification system 100 may determine that the name of the first speaker 150 who spoke the first words 162 is “Alex.” Based on this determination, the speaker name identification system 100 may output an indication of the first speaker name, for example, a text indication 166 representing “First Speaker=Alex” and may associate the text indication 166 with the first words 162 spoken by the first speaker.

Continuing with the first example conversation 160, the speaker name identification system 100 may process another portion of the data 104 which may be the second words 164 including “Hi I am Joe”. The speaker name identification system 100 may determine the speaker's intent to be a self-introduction intent, and may determine “Joe” is a name represented in the second words 164. Based on the self-introduction intent, the speaker name identification system 100 may determine that the name of the second speaker 152 who spoke the second words 164 is “Joe.” Based on this determination, the speaker name identification system 100 may output an indication of the second speaker name, for example, a text indication 168 representing “Second Speaker=Joe” and may associate the text indication 168 with the second words 164 spoken by the second speaker.

For the second example conversation 170, the first portion of the data 104 may be the first words 172 including “Joe, can I ask you a question?” The speaker name identification system 100 may determine the speaker's intent to be a question intent, and may determine “Joe” is a name represented in the first words 172. The speaker name identification system 100 may further determine that the second words 174 follow the first words 172. In some implementations, the speaker name identification system 100 may determine that the second words 174 including “Yes, I can answer that” is responsive to the first words 172 including “Joe, can I ask you a question?” Based on (1) the question intent associated with the first words 172, (2) a name included in the first words 172, and (3) the second words 174 spoken by the second speaker 152 following the first words 172, the speaker name identification system 100 may determine that the name of the second speaker 152 who spoke the second words 174 is “Joe.” Based on this determination, the speaker name identification system 100 may output an indication of the second speaker name, for example, a text indication 178 representing “Second Speaker=Joe” and may associate the text indication 178 with the second words 174 spoken by the second speaker.

For the third example conversation 180, the first portion of the data 104 may be the first words 182 including “Let me introduce Joe who will be speaking about . . . ” The speaker name identification system 100 may determine the speaker's intent to be an intent to introduce another person, and may determine “Joe” is a name represented in the first words 182. The speaker name identification system 100 may further determine that the second words 184, spoken by another/the second speaker 152, follow the first words 182. Based on (1) the intent to introduce another person associated with the first words 182, (2) a name included in the first words 182, and (3) the second words 184 being spoken by the second speaker 152 following the first words 182, the speaker name identification system 100 may determine that the name of the second speaker 152 who spoke the second words 184 is “Joe.” Based on this determination, the speaker name identification system 100 may output an indication of the second speaker name, for example, a text indication 188 representing “Second Speaker=Joe” and may associate the text indication 188 with the second words 184 spoken by the second speaker.

Further for the third example conversation 180, a second portion of the data 104 may be the second words 184 including “Thank you Alex for the introduction.” The speaker name identification system 100 may determine the speaker's intent for the second words 184 to be an intent to respond/engage another person, and may determine “Alex” is a name represented in the second words 184. The speaker name identification system 100 may further determine that the second words 184 follow the first words 182 spoken by another/first speaker 150. Based on the (1) intent to respond/engage another person, (2) a name included in the second words 184, and (3) the first words 182 being spoken by the first speaker 150 preceding the second words 184 spoken by the second speaker 152, the speaker name identification system 100 may determine that the name of the first speaker 150 who spoke the first words 182 is “Alex.” Based on this determination, the speaker name identification system 100 may output an indication of the first speaker name, for example, a text indication 186 representing “First Speaker=Alex” and may associate the text indication 186 with the first words 182 spoken by the first speaker.

In this manner, the speaker name identification system 100 uses speaker intents and names mentioned by persons to identify speaker names from data representing words spoken by multiple persons, and outputs an indication of the speaker names.

Additional details and example implementations of embodiments of the present disclosure are set forth below in Section F, following a description of example systems and network environments in which such embodiments may be deployed.

### B. Network Environment

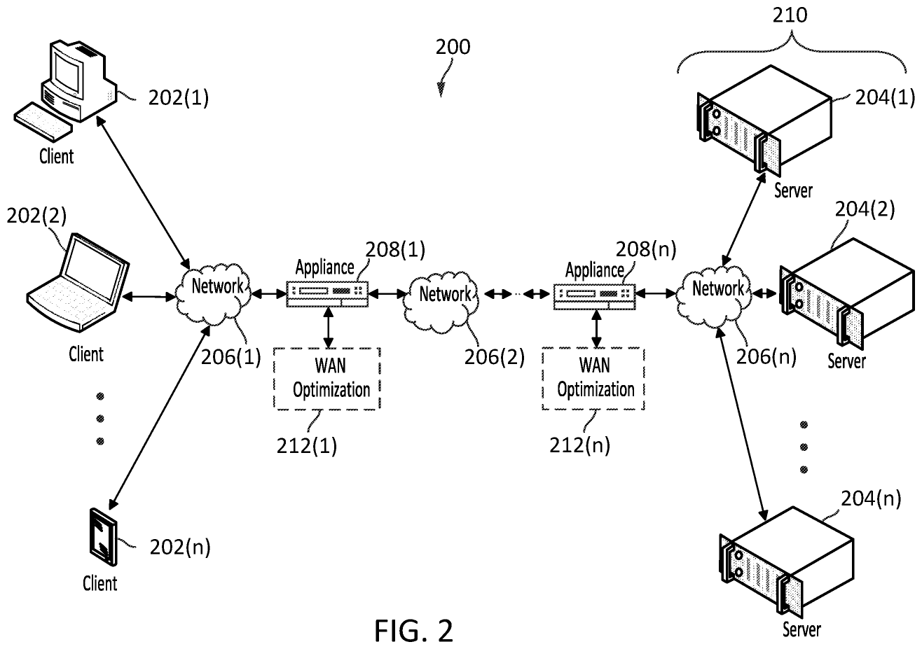

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one or more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

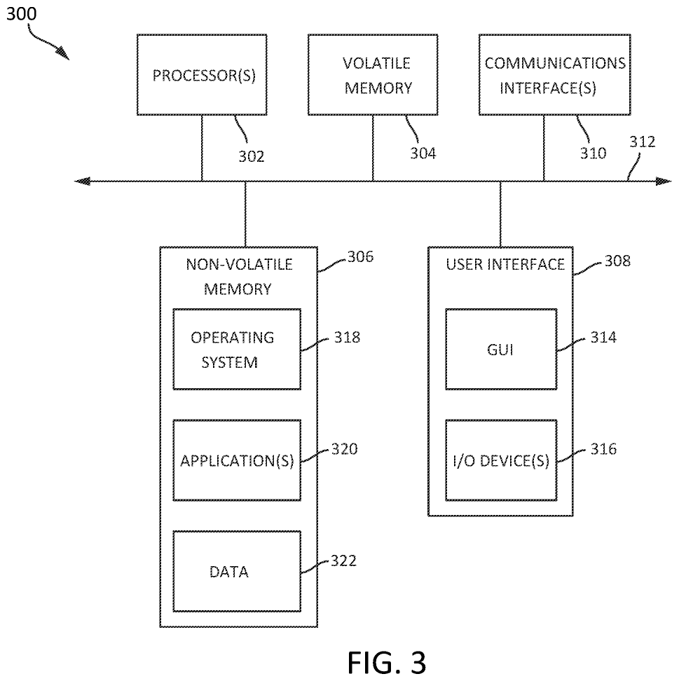

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

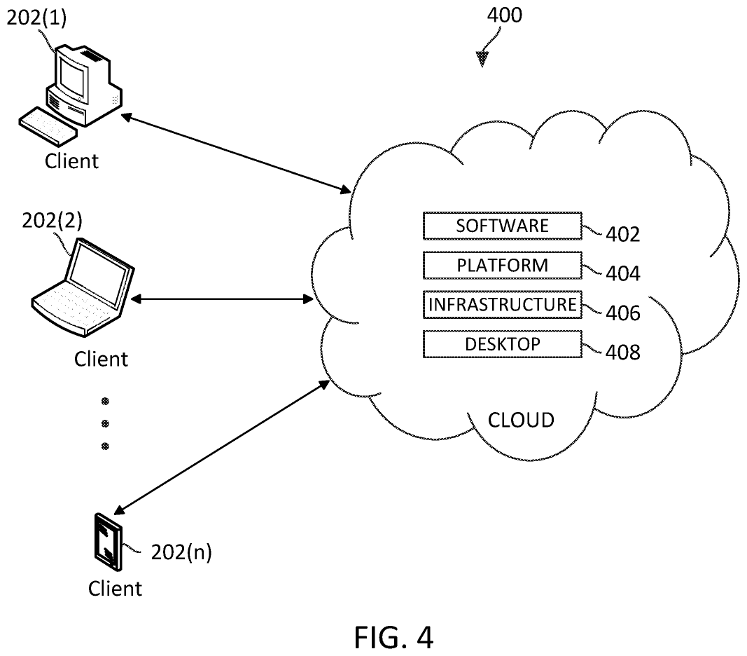

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g., Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Systems and Methods for Providing File Sharing Over Network(s)

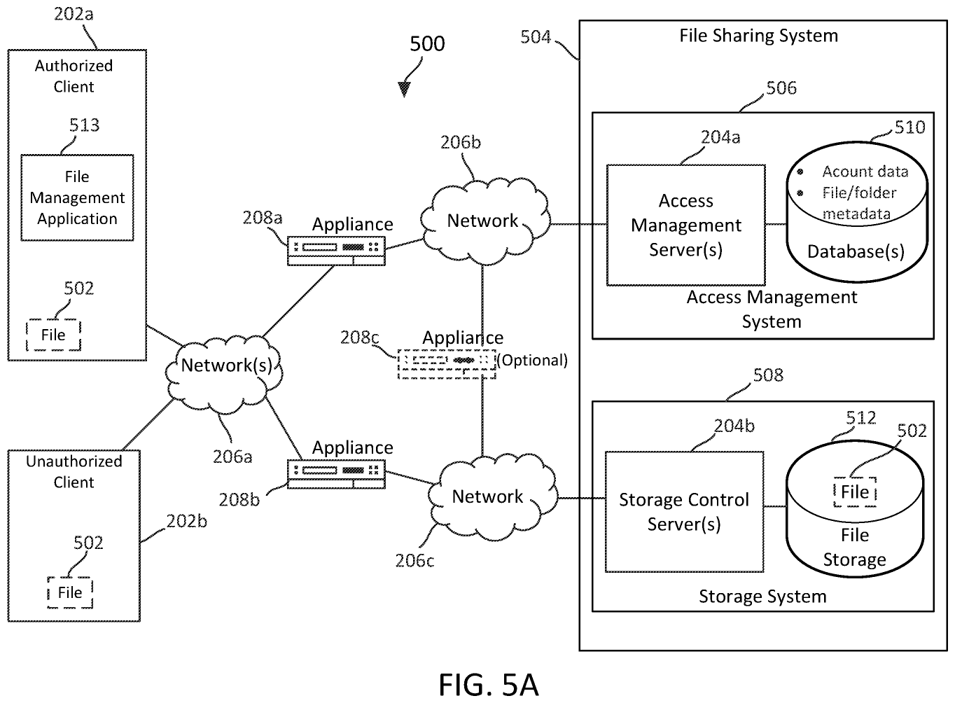

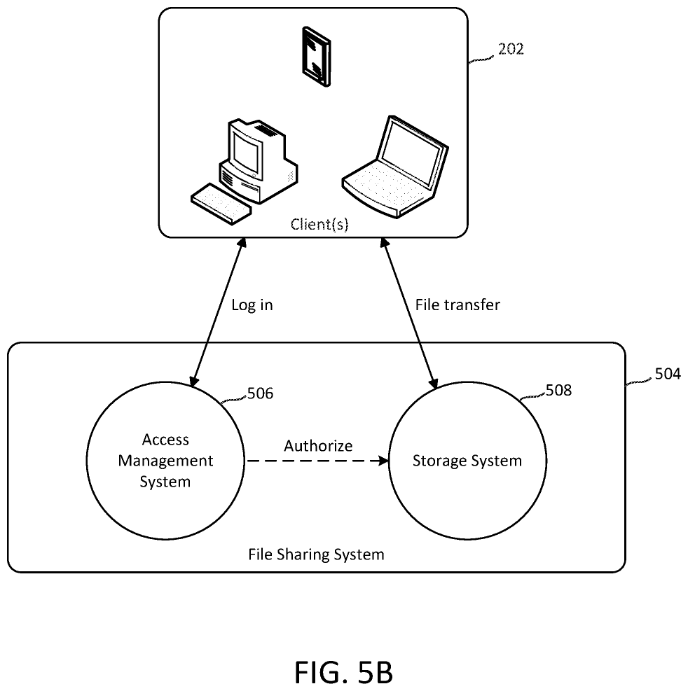

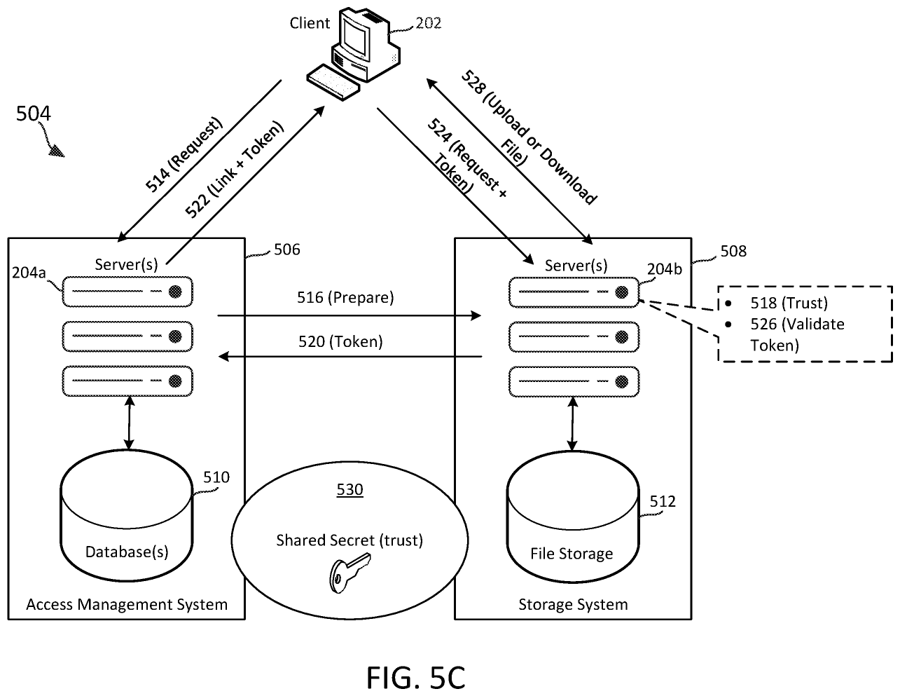

FIG. 5A shows an example network environment 500 for allowing an authorized client 202a and/or an unauthorized client 202b to upload a file 502 to a file sharing system 504 or download a file 502 from the file sharing system 504. The authorized client 202a may, for example, be a client 202 operated by a user having an active account with the file sharing system 504, while the unauthorized client 202b may be operated by a user who lacks such an account. As shown, in some embodiments, the authorized client 202a may include a file management application 513 with which a user of the authorized client 202a may access and/or manage the accessibility of one or more files 502 via the file sharing system 504. The file management application 513 may, for example, be a mobile or desktop application installed on the authorized client 202a (or in a computing environment accessible by the authorized client). The ShareFile® mobile app and the ShareFile® desktop app offered by Citrix Systems, Inc., of Fort Lauderdale, Fla., are examples of such preinstalled applications. In other embodiments, rather than being installed on the authorized client 202a, the file management application 513 may be executed by a web server (included with the file sharing system 504 or elsewhere) and provided to the authorized client 202a via one or more web pages.

As FIG. 5A illustrates, in some embodiments, the file sharing system 504 may include an access management system 506 and a storage system 508. As shown, the access management system 506 may include one or more access management servers 204a and a database 510, and the storage system 508 may include one or more storage control servers 204b and a storage medium(s) 512. In some embodiments, the access management server(s) 204a may, for example, allow a user of the file management application 513 to log in to his or her account, e.g., by entering a user name and password corresponding to account data stored in the database 510. Once the user of the client 202a has logged in, the access management server 204a may enable the user to view (via the authorized client 202a) information identifying various folders represented in the storage medium(s) 512, which is managed by the storage control server(s) 204b, as well as any files 502 contained within such folders. File/folder metadata stored in the database 510 may be used to identify the files 502 and folders in the storage medium(s) 512 to which a particular user has been provided access rights.

In some embodiments, the clients 202a, 202b may be connected to one or more networks 206a (which may include the Internet), the access management server(s) 204a may include webservers, and an appliance 208a may load balance requests from the authorized client 202a to such webservers. The database 510 associated with the access management server(s) 204a may, for example, include information used to process user requests, such as user account data (e.g., username, password, access rights, security questions and answers, etc.), file and folder metadata (e.g., name, description, storage location, access rights, source IP address, etc.), and logs, among other things. Although the clients 202a, 202b are shown is FIG. 5A as stand-alone computers, it should be appreciated that one or both of the clients 202a, 202b shown in FIG. 5A may instead represent other types of computing devices or systems that can be operated by users. In some embodiments, for example, one or both of the authorized client 202a and the unauthorized client 202b may be implemented as a server-based virtual computing environment that can be remotely accessed using a separate computing device operated by users, such as described above.

In some embodiments, the access management system 506 may be logically separated from the storage system 508, such that files 502 and other data that are transferred between clients 202 and the storage system 508 do not pass through the access management system 506. Similar to the access management server(s) 204a, one or more appliances 208b may load-balance requests from the clients 202a, 202b received from the network(s) 206a (which may include the Internet) to the storage control server(s) 204b. In some embodiments, the storage control server(s) 204b and/or the storage medium(s) 512 may be hosted by a cloud-based service provider (e.g., Amazon Web Services™ or Microsoft Azure™). In other embodiments, the storage control server(s) 204b and/or the storage medium(s) 512 may be located at a data center managed by an enterprise of a client 202, or may be distributed among some combination of a cloud-based system and an enterprise system, or elsewhere.

After a user of the authorized client 202a has properly logged in to an access management server 204a, the server 204a may receive a request from the client 202a for access to one of the files 502 or folders to which the logged in user has access rights. The request may either be for the authorized client 202a to itself to obtain access to a file 502 or folder or to provide such access to the unauthorized client 202b. In some embodiments, in response to receiving an access request from an authorized client 202a, the access management server 204a may communicate with the storage control server(s) 204b (e.g., either over the Internet via appliances 208a and 208b or via an appliance 208c positioned between networks 206b and 206c) to obtain a token generated by the storage control server 204b that can subsequently be used to access the identified file 502 or folder.

In some implementations, the generated token may, for example, be sent to the authorized client 202a, and the authorized client 202a may then send a request for a file 502, including the token, to the storage control server(s) 204b. In other implementations, the authorized client 202a may send the generated token to the unauthorized client 202b so as to allow the unauthorized client 202b to send a request for the file 502, including the token, to the storage control server(s) 204b. In yet other implementations, an access management server 204a may, at the direction of the authorized client 202a, send the generated token directly to the unauthorized client 202b so as to allow the unauthorized client 202b to send a request for the file 502, including the token, to the storage control server(s) 204b. In any of the forgoing scenarios, the request sent to the storage control server(s) 204b may, in some embodiments, include a uniform resource locator (URL) that resolves to an internet protocol (IP) address of the storage control server(s) 204b, and the token may be appended to or otherwise accompany the URL. Accordingly, providing access to one or more clients 202 may be accomplished, for example, by causing the authorized client 202a to send a request to the URL address, or by sending an email, text message or other communication including the token-containing URL to the unauthorized client 202b, either directly from the access management server(s) 204a or indirectly from the access management server(s) 204a to the authorized client 202a and then from the authorized client 202a to the unauthorized client 202b. In some embodiments, selecting the URL or a user interface element corresponding to the URL, may cause a request to be sent to the storage control server(s) 204b that either causes a file 502 to be downloaded immediately to the client that sent the request, or may cause the storage control server 204b to return a webpage to the client that includes a link or other user interface element that can be selected to effect the download.

In some embodiments, a generated token can be used in a similar manner to allow either an authorized client 202a or an unauthorized client 202b to upload a file 502 to a folder corresponding to the token. In some embodiments, for example, an “upload” token can be generated as discussed above when an authorized client 202a is logged in and a designated folder is selected for uploading. Such a selection may, for example, cause a request to be sent to the access management server(s) 204a, and a webpage may be returned, along with the generated token, that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In some embodiments, sending a request including such a token to the storage control server(s) 204b (e.g., by selecting a URL or user-interface element included in an email inviting the user to upload one or more files 502 to the file sharing system 504), a webpage may be returned that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In the described embodiments, the clients 202, servers 204, and appliances 208 and/or 212 (appliances 212 are shown in FIG. 2) may be deployed as and/or executed on any type and form of computing device, such as any desktop computer, laptop computer, rack-mounted computer, or mobile device capable of communication over at least one network and performing the operations described herein. For example, the clients 202, servers 204 and/or appliances 208 and/or 212 may correspond to respective computing systems, groups of computing systems, or networks of distributed computing systems, such as computing system 300 shown in FIG. 3.

As discussed above in connection with FIG. 5A, in some embodiments, a file sharing system may be distributed between two sub-systems, with one subsystem (e.g., the access management system 506) being responsible for controlling access to files 502 stored in the other subsystem (e.g., the storage system 508). FIG. 5B illustrates conceptually how one or more clients 202 may interact with two such subsystems.

As shown in FIG. 5B, an authorized user operating a client 202, which may take on any of numerous forms, may log in to the access management system 506, for example, by entering a valid user name and password. In some embodiments, the access management system 506 may include one or more webservers that respond to requests from the client 202. The access management system 506 may store metadata concerning the identity and arrangements of files 502 (shown in FIG. 5A) stored by the storage system 508, such as folders maintained by the storage system 508 and any files 502 contained within such folders. In some embodiments, the metadata may also include permission metadata identifying the folders and files 502 that respective users are allowed to access. Once logged in, a user may employ a user-interface mechanism of the client 202 to navigate among folders for which the metadata indicates the user has access permission.

In some embodiments, the logged-in user may select a particular file 502 the user wants to access and/or to which the logged-in user wants a different user of a different client 202 to be able to access. Upon receiving such a selection from a client 202, the access management system 506 may take steps to authorize access to the selected file 502 by the logged-in client 202 and/or the different client 202. In some embodiments, for example, the access management system 506 may interact with the storage system 508 to obtain a unique “download” token which may subsequently be used by a client 202 to retrieve the identified file 502 from the storage system 508. The access management system 506 may, for example, send the download token to the logged-in client 202 and/or a client 202 operated by a different user. In some embodiments, the download token may a single-use token that expires after its first use.

In some embodiments, the storage system 508 may also include one or more webservers and may respond to requests from clients 202. In such embodiments, one or more files 502 may be transferred from the storage system 508 to a client 202 in response to a request that includes the download token. In some embodiments, for example, the download token may be appended to a URL that resolves to an IP address of the webserver(s) of the storage system 508. Access to a given file 502 may thus, for example, be enabled by a “download link” that includes the URL/token. Such a download link may, for example, be sent the logged-in client 202 in the form of a “DOWNLOAD” button or other user-interface element the user can select to effect the transfer of the file 502 from the storage system 508 to the client 202. Alternatively, the download link may be sent to a different client 202 operated by an individual with which the logged-in user desires to share the file 502. For example, in some embodiments, the access management system 506 may send an email or other message to the different client 202 that includes the download link in the form of a “DOWNLOAD” button or other user-interface element, or simply with a message indicating “Click Here to Download” or the like. In yet other embodiments, the logged-in client 202 may receive the download link from the access management system 506 and cut-and-paste or otherwise copy the download link into an email or other message the logged in user can then send to the other client 202 to enable the other client 202 to retrieve the file 502 from the storage system 508.

In some embodiments, a logged-in user may select a folder on the file sharing system to which the user wants to transfer one or more files 502 (shown in FIG. 5A) from the logged-in client 202, or to which the logged-in user wants to allow a different user of a different client 202 to transfer one or more files 502. Additionally or alternatively, the logged-in user may identify one or more different users (e.g., by entering their email addresses) the logged-in user wants to be able to access one or more files 502 currently accessible to the logged-in client 202.

Similar to the file downloading process described above, upon receiving such a selection from a client 202, the access management system 506 may take steps to authorize access to the selected folder by the logged-in client 202 and/or the different client 202. In some embodiments, for example, the access management system 506 may interact with the storage system 508 to obtain a unique “upload token” which may subsequently be used by a client 202 to transfer one or more files 502 from the client 202 to the storage system 508. The access management system 506 may, for example, send the upload token to the logged-in client 202 and/or a client 202 operated by a different user.

One or more files 502 may be transferred from a client 202 to the storage system 508 in response to a request that includes the upload token. In some embodiments, for example, the upload token may be appended to a URL that resolves to an IP address of the webserver(s) of the storage system 508. For example, in some embodiments, in response to a logged-in user selecting a folder to which the user desires to transfer one or more files 502 and/or identifying one or more intended recipients of such files 502, the access management system 506 may return a webpage requesting that the user drag-and-drop or otherwise identify the file(s) 502 the user desires to transfer to the selected folder and/or a designated recipient. The returned webpage may also include an “upload link,” e.g., in the form of an “UPLOAD” button or other user-interface element that the user can select to effect the transfer of the file(s) 502 from the client 202 to the storage system 508.

In some embodiments, in response to a logged-in user selecting a folder to which the user wants to enable a different client 202 operated by a different user to transfer one or more files 502, the access management system 506 may generate an upload link that may be sent to the different client 202. For example, in some embodiments, the access management system 506 may send an email or other message to the different client 202 that includes a message indicating that the different user has been authorized to transfer one or more files 502 to the file sharing system, and inviting the user to select the upload link to effect such a transfer. Section of the upload link by the different user may, for example, generate a request to webserver(s) in the storage system and cause a webserver to return a webpage inviting the different user to drag-and-drop or otherwise identify the file(s) 502 the different user wishes to upload to the file sharing system 504. The returned webpage may also include a user-interface element, e.g., in the form of an “UPLOAD” button, that the different user can select to effect the transfer of the file(s) 502 from the client 202 to the storage system 508. In other embodiments, the logged-in user may receive the upload link from the access management system 506 and may cut-and-paste or otherwise copy the upload link into an email or other message the logged-in user can then send to the different client 202 to enable the different client to upload one or more files 502 to the storage system 508.

In some embodiments, in response to one or more files 502 being uploaded to a folder, the storage system 508 may send a message to the access management system 506 indicating that the file(s) 502 have been successfully uploaded, and an access management system 506 may, in turn, send an email or other message to one or more users indicating the same. For user's that have accounts with the file sharing system 504, for example, a message may be sent to the account holder that includes a download link that the account holder can select to effect the transfer of the file 502 from the storage system 508 to the client 202 operated by the account holder. Alternatively, the message to the account holder may include a link to a webpage from the access management system 506 inviting the account holder to log in to retrieve the transferred files 502. Likewise, in circumstances in which a logged-in user identifies one or more intended recipients for one or more to-be-uploaded files 502 (e.g., by entering their email addresses), the access management system 506 may send a message including a download link to the designated recipients (e.g., in the manner described above), which such designated recipients can then use to effect the transfer of the file(s) 502 from the storage system 508 to the client(s) 202 operated by those designated recipients.

FIG. 5C is a block diagram showing an example of a process for generating access tokens (e.g., the upload tokens and download tokens discussed above) within the file sharing system 504 described in connection with FIGS. 5A and 5B.

As shown, in some embodiments, a logged-in client 202 may initiate the access token generation process by sending an access request 514 to the access management server(s) 204b. As noted above, the access request 514 may, for example, correspond to one or more of (A) a request to enable the downloading of one or more files 502 (shown in FIG. 5A) from the storage system 508 to the logged-in client 202, (B) a request to enable the downloading of one or more files 502 from the storage system 508 to a different client 202 operated by a different user, (C) a request to enable the uploading of one or more files 502 from a logged-in client 202 to a folder on the storage system 508, (D) a request to enable the uploading of one or more files 502 from a different client 202 operated by a different user to a folder of the storage system 508, (E) a request to enable the transfer of one or more files 502, via the storage system 508, from a logged-in client 202 to a different client 202 operated by a different user, or (F) a request to enable the transfer of one or more files 502, via the storage system 508, from a different client 202 operated by a different user to a logged-in client 202.

In response to receiving the access request 514, an access management server 204a may send a “prepare” message 516 to the storage control server(s) 204b of the storage system 508, identifying the type of action indicated in the request, as well as the identity and/or location within the storage medium(s) 512 of any applicable folders and/or files 502. As shown, in some embodiments, a trust relationship may be established (step 518) between the storage control server(s) 204b and the access management server(s) 204a. In some embodiments, for example, the storage control server(s) 204b may establish the trust relationship by validating a hash-based message authentication code (HMAC) based on shared secret or key 530).

After the trust relationship has been established, the storage control server(s) 204b may generate and send (step 520) to the access management server(s) 204a a unique upload token and/or a unique download token, such as those as discussed above.

After the access management server(s) 204a receive a token from the storage control server(s) 204b, the access management server(s) 204a may prepare and send a link 522 including the token to one or more client(s) 202. In some embodiments, for example, the link may contain a fully qualified domain name (FQDN) of the storage control server(s) 204b, together with the token. As discussed above, the link 522 may be sent to the logged-in client 202 and/or to a different client 202 operated by a different user, depending on the operation that was indicated by the request.

The client(s) 202 that receive the token may thereafter send a request 524 (which includes the token) to the storage control server(s) 204b. In response to receiving the request, the storage control server(s) 204b may validate (step 526) the token and, if the validation is successful, the storage control server(s) 204b may interact with the client(s) 202 to effect the transfer (step 528) of the pertinent file(s) 502, as discussed above.

### F. Detailed Description of Example Embodiments of a Speaker Name Identification System

Various file sharing systems have been developed that allow users to upload files and share them with other users over a network. An example of such a file sharing system 504 is described above (in Section E) in connection with FIGS. 5A-C. As explained in Section E, in some implementations, one client device 202 may upload a file 502 (shown in FIG. 5A) to a central repository of the file sharing system 504, such as a storage medium(s) 512 shown in FIGS. 5A and C. In some implementations, the speaker name identification system 100 (introduced in Section A) may be included in the file sharing system 504 or may be in communication with the file sharing system 504, and may operate on the file 502, which may be an audio file, a video file, or text-based file representing words spoken by multiple persons.

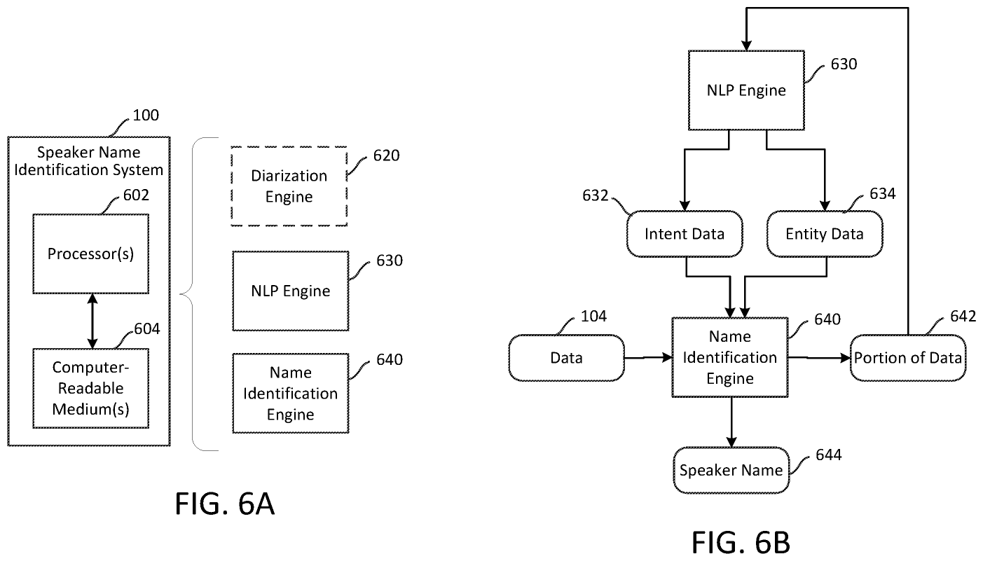

FIG. 6A illustrates an example implementation of the speaker name identification system 100 introduced in Section A. As shown, in some implementations, the speaker name identification system 100 may include one or more processors 602 as well as one or more computer-readable mediums 604 that are encoded with instructions to be executed by the processor(s) 602. In some implementations, such instructions may cause the processor(s) 602 to implement one or more, or possibly all, of the engines shown in FIG. 6A and/or the operations of the speaker name identification system 100 described herein. In some implementations, the speaker name identification system 100 may include a diarization engine 620, a natural language processing (NLP) engine 630 and a name identification engine 640.

The processor(s) 602 and computer-readable medium(s) 604 may be disposed at any of a number of locations within a computing network such as the network environment 200 described above (in Section B) in connection with FIG. 2. One or more of the engines 620, 630 and 640 may be implemented in any of numerous ways and may be disposed at any of a number of locations within a computing network such as the network environment 200. In some implementations, for example, the processor(s) 602 and the computer-readable medium(s) 604 embodying one or more such components may be located within one or more of the servers 204 and/or the computing system 300 that are described above (in Sections B and C) in connection with FIGS. 2 and 3, and/or may be located within a cloud computing environment 400 such as that described above (in Section D) in connection with FIG. 4.

In some implementations, the speaker name identification system 100 may include the diarization engine 620, which may be configured to transcribe an audio recording and generally identify different speakers. The diarization engine 620 may use one or more speech-to-text techniques and/or speech recognition techniques to transcribe the audio recording. The speech-to-text techniques may involve using one or more of machine learning models (e.g., acoustic models, language models, neural network models, etc.), acoustic feature extraction techniques, sequential audio frame processing, non-sequential audio frame processing, and other techniques.

The diarization engine 620 may use one or more speaker diarization techniques to recognize multiple speakers in the same audio recording. The speaker diarization techniques may involve using one or more of machine learning models (e.g., neural network models, etc.), acoustic feature extraction techniques, sequential audio frame processing, non-sequential audio frame processing, audio feature-based speaker segmentation, audio features clustering, and other techniques. Speaker diarization techniques may also be referred to as speaker segmentation and clustering techniques, and may involve a process of partitioning an input audio stream into homogeneous segments according to speaker identity.

In some implementations, the diarization engine 620 may detect when speakers change, based on changes in the audio data, and may generate a label based on the number the individual voices detected in the audio. The diarization engine 620 may attempt to distinguish the different voices included in the audio data, and in some implementations, may label individual words with a number (or other generic indication) assigned to individual speakers. Words spoken by the same speaker may be tagged with the same number. In some implementations, the diarization engine 620 may tag groups of words (e.g., each sentence) with the speaker number, instead of tagging individual words. In some implementations, the diarization engine 620 may change the speaker number tag for the words when words from another speaker begin.

In some implementations, the diarization engine 620 may first transcribe the audio data (that is, generate text representing words captured in the audio), then process the audio data along with the transcription to distinguish the different voices in the audio data and tag the words in the transcription with an appropriate speaker number. In other implementations, the diarization engine 620 may process the audio data to generate a transcription, word-by-word, and tag words with a speaker number as it is transcribed.

The diarization engine 620 may output the data 104 representing words spoken by multiple persons (shown in and described in relation to FIG. 1A). The data 104, outputted by the diarization engine 620, may be a transcript including words spoken by multiple persons, and including a generic indication or label for different speakers. For example, the data 104 outputted by the diarization engine 620 may be text data representing first words spoken by a first speaker identified as speaker A (or first speaker, speaker 1, etc.), second words spoken by a second speaker identified as speaker B (or second speaker, speaker 2, etc.), third words spoken by a third speaker identified as speaker C (or third speaker, speaker 3, etc.), and so on. The data 104 may be structured by speaker turns.

In some implementations, the diarization engine 620 (or a component that performs similar operations) may be provided at the client device 202, or may be located remotely (e.g., on one or more servers 204) and accessed by the client device 202 via a network. The diarization engine 620 may be provided as a service or an application that the client device 202 may access via a web-browser or by downloading the application. In such implementations, the user 102 may provide, via the client device 202, an audio (or video) file to the diarization engine 620, which in turn may output the data 104.

In some implementations, the speaker name identification system 100 may include the NLP engine 630, which may be configured to process portions of a transcript (represented by the data 104) to determine a speaker's intent associated with one or more portions of the transcript, and determine an entity name included in such portions. The NLP engine 630 may use one or more NLP techniques including NER techniques. NLP techniques may involve understanding a meaning of what a person said, and the meaning may be represented as an intent. NLP techniques may involve use of as natural language understanding (NLU) techniques. The NLP engine 630 may use one or more of a lexicon of a natural language, a parser, grammar models/rules, and a semantics engine to determine a speaker's intent.

NER techniques may involve determining which entity or entities are mentioned by a person, and classifying the mentioned entities based on a type (e.g., an entity type). NER techniques may classify a mentioned entity into one of the following types: person, place, or thing. For example, the NER techniques may identify a word, in the transcript, that is an entity, and may determine that the word is a person. In other implementations, the entity type classes may include more entity types (e.g., numerical values, time expressions, organizations, quantities, monetary values, percentages, etc.). NER techniques may also be referred to as entity identification techniques, entity chunking techniques, or entity extraction techniques. NER techniques may use one or more of grammar models/rules, statistical models, and machine learning models (e.g., classifiers, etc.).

The speaker name identification system 100 may also include the name identification engine 640, which may be configured to determine portions of the data 104 to be processed, determine a speaker name based on the speaker's intent and person name determined by the NLP engine, and keep track of the identified speaker names. The name identification engine 640 may use one or more of machine learning models and rule-based engines to determine the speaker name.

In some implementations, the name identification engine 640 may use one or more dialog flow models that may be configured to recognize a speaker name based on a speaker's intent. The dialog flow models may be trained using sample dialogs that may include sequences of sentences that can be used to determine a speaker name. Often during conversations, a person may introduce himself/herself using his/her name, or a person may refer to another person by name, which may cause the other person to respond/speak next. These types of scenarios or other similar scenarios may be simulated in the sample dialogs used to train the dialog flow models. In some implementations, the dialog flow models may include an intent corresponding to the dialog or corresponding to sentences in the dialog.

The name identification engine 640 may use a table (or other data structure) to track which speaker names have been identified. Further details on the processing performed by the name identification engine 640 are described below in relation to FIGS. 6B and 7-10.

FIG. 6B shows an example of how data 104 may be processed by the engines of the speaker name identification system 100. As shown, the name identification engine 640 may receive the data 104 representing words spoken by multiple persons. The data 104 may, for example, be outputted by the diarization engine 620, and may include generic speaker labels identifying which words are spoken by which different speaker. The name identification engine 640 may determine a portion of data 642 from the data 104. The portion of data 642 may represent a sentence represented in the data 104. In other implementations, the portion of data 642 may represent more than one sentence, and/or may represent consecutive words/sentences spoken by a (first) speaker before another (second) speaker starts speaking.

The NLP engine 630 may process the portion of data 642, may output intent data 632 representing a speaker's intent associated with the portion of data 642, and may also output entity data 634 representing an entity name included in the portion of data 642. The entity data 634 may also represent an entity type corresponding to the entity name.

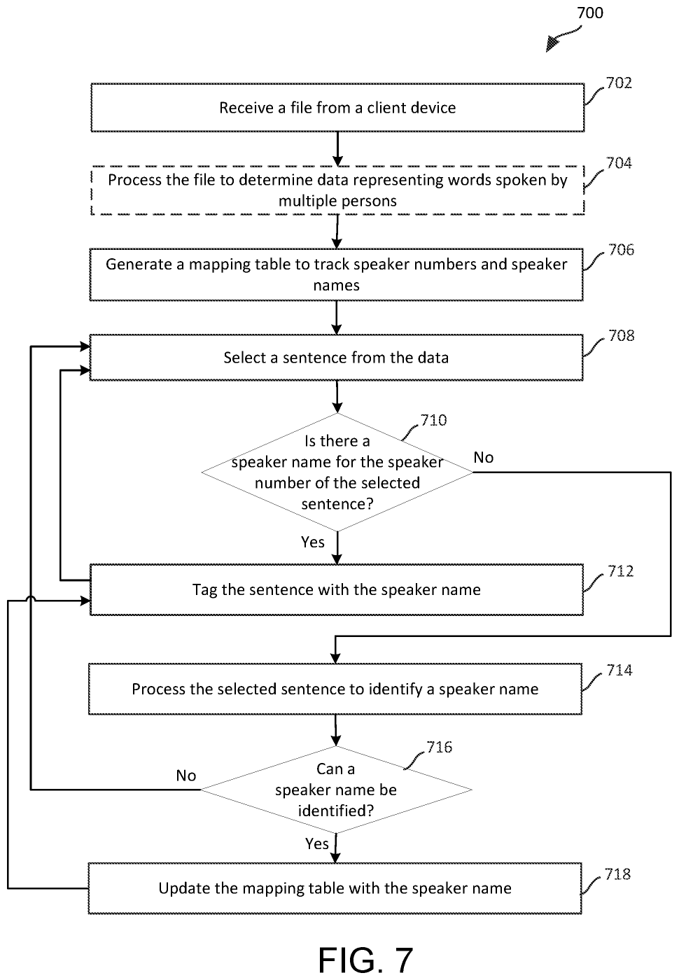

The name identification engine 640 may process the intent data 632 and the entity data 634 to determine whether a speaker name can be derived from the portion of data 642. For example, the name identification engine 640 may first determine if the intent data 632 represents a speaker intent that can be used to determine a speaker name. Next or in parallel, the name identification engine 640 may determine if the entity data 634 represents a person name. Based on the speaker intent and whether or not the entity data 634 represents a person name, the name identification engine 640 may determine the speaker name 644 or may determine to process another portion of the data 104, as described below in relation to FIG. 7.

FIG. 7 shows a first example routine 700 that may be performed by the speaker name identification system 100 for determining a speaker name from data representing words spoken by multiple persons. At a step 702 of the routine 700, the speaker name identification system 100 may receive a file from a client device 202. As described herein, in some implementations, the speaker name identification system 100 may be part of the file sharing system 504, and the file received at the step 702 may be the file 502. In some cases, the received file may be an audio file or a video file capturing speech from multiple persons. In other cases, the received file may be text file representing a transcript of words spoken by multiple persons. In some cases, the speaker name identification system 100 may receive both an audio (or video) file and a corresponding transcript.

In the case that the received file is an audio or video file, the diarization engine 620 of the speaker name identification system 100 may, at a step 704 of the routine 700, process the file to determine the data 104 representing words spoken by multiple persons. As described above, the diarization engine 620 may use one or more speaker diarization techniques to determine the data 104. The data 104 may include speaker numbers associated with the words, where the speaker number may generically identify the speaker that spoke the associated word. Different speakers detected in the audio may be assigned a unique identifier (e.g., a speaker number).

At a step 706 of the routine, the name identification engine 640 of the speaker name identification system 100 may generate a table (e.g., a mapping table) to track the speaker numbers and corresponding speaker names. The table may include a separate entry for different speaker numbers included in the data 104. For example, if the data 104 includes speaker numbers 1 through 5, then the table may include a first entry for speaker 1, a second entry for speaker 2, a third entry for speaker 3, a fourth entry for speaker 4, and a fifth entry for speaker 5. At the step 706, the name identification engine 640 may keep the corresponding speaker names empty (or store a null value). These speaker names will be later updated after the speaker name identification system 100 determines the speaker name. In some implementations, the table may be a key-value map, where the speaker number may be the key and the corresponding value may be the speaker name. In some implementations, generic labels other than numbers may be used to identify the speaker, such as, alphabetical labels (e.g., speaker A, speaker B, etc.), ordinal labels (e.g., first speaker, second speaker, etc.), etc. The table may include an appropriate entry for the generic label used in the data 104.

At a step 708 of the routine 700, the name identification engine 640 may select pieces (e.g., a sentence) from the data 104. In some implementations, the name identification engine 640 may select more than one sentence. The selected sentence may be associated with a speaker number in the data 104. At a decision block 710, the name identification engine 640 may determine if there is a speaker name for the speaker number associated with the selected sentence. To make this determination, the name identification engine 640 may use the table (generated in the step 706).

If there is a speaker name corresponding to the speaker number associated with the selected piece of content (e.g., sentence) in the table, then at a step 712, the name identification engine 640 may tag the sentence with the speaker name. In some implementations, the name identification engine 640 may insert a tag (e.g., text) in the data 104, representing the speaker name. In other implementations, the name identification engine 640 may replace the speaker name in the data 104 with the speaker name. In yet other implementations, the name identification engine 640 may generate another file including text representing the sentence and associate the text with a tag representing the speaker name. After the step 712, the name identification engine 640 may select another piece (e.g., a different sentence) from the data 104 per the step 708, and may continue with the routine 700 from that point.

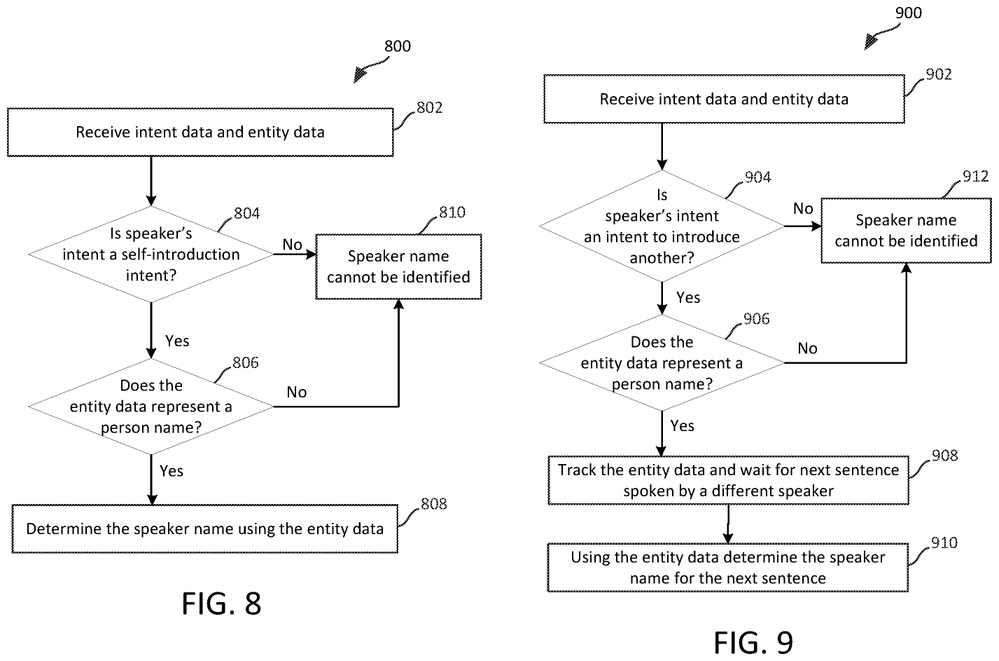

If there is no speaker name corresponding to the speaker number associated with the selected content in the table, then at a step 714, the name identification engine 640 may process the sentence to identify a speaker name. At the step 714, the name identification engine 640 may provide the sentence as the portion of data 642 to the NLP engine 630 for processing. As described in relation to FIG. 6B, the NLP engine 630 may output the intent data 632 and the entity data 634 based on processing the portion of data 642. The NLP engine 630 may process the intent data 632 and the entity data 634, as described below in relation to FIGS. 8-10 to determine the speaker name 644. As described below, in some cases, the name identification engine 640 may not be able to identify a speaker name by processing the selected sentence based on the speaker's intent and the entity mentioned in the sentence. At a decision block 716, the name identification engine 640 may determine whether a speaker name can be identified. If a speaker name cannot be identified, based on processing the selected sentence, then, at the step 708, the name identification engine 640 may select another sentence from the data 104 and may continue with the routine 700 from that point.

If the speaker name 644 can be identified based on processing the selected sentence, then at a step 718, the name identification engine 640 may update the mapping table with the speaker name 644. The name identification engine 640 may store the speaker name 644 in the mapping table as the value corresponding to the speaker name that is associated with the selected sentence. For example, the mapping table may include the following key-value pair (speaker 1→“Joe”).

After (or in parallel of) updating the table (e.g., a mapping table), the name identification engine 640 may perform the step 712 (described above) and tag the sentence with the speaker name. The routine 700 may continue from there, which may involve the name identification engine 640 perform the step 708 to select another sentence from the data 104. In some implementations, the name identification engine 640 may select the next sentence (or next portion) from the data 104, and perform the routine 700 to identify a speaker name associated with the sentence. Such identification may involve determining a speaker name, from the mapping table, for the speaker number associated with the selected sentence or deriving the speaker name by processing the selected sentence.

In some implementations, the speaker name identification system 100 may perform the routine 700 until all of the sentences (or portions) represented in the data 104 are processed. In other implementations, the speaker name identification system 100 may perform the routine 700 until the table (e.g., a mapping table) includes a speaker name for individual speaker numbers identified in the data 104. In such implementations, after the speaker names for the speaker numbers are identified, the speaker name identification system 100 may tag or otherwise identify the sentences (or portions) represented in the data 104 with the speaker name based on the speaker number associated with the respective sentences.

After the speaker names have been identified, the speaker name identification system 100 may output the indication 106 (shown in FIG. 1A) identifying the speaker names for the words represented in the data 104. The indication 106 may be text representing that the words spoken by the speaker name. In some implementations, the speaker name identification system 100 may insert the indication 106 in the transcript represented by the data 104. Additionally or alternatively, in some implementations, the speaker name identification system 100 may insert the indication 106 in the audio or video file, if provided by the user 102, to indicate the words spoken by the speaker name.

FIG. 8 shows a second example routine 800 that may be performed by the name identification engine 640 as part of the step 714 of the routine 700 shown in FIG. 7. At a step 802 of the routine 800, the name identification engine 640 may receive the intent data 632 and the entity data 634 from the NLP engine 630. At a decision block 804, the name identification engine 640 may determine whether the speaker's intent (included in the intent data 632) is a self-introduction intent. A self-introduction intent may be when a person introduces him/herself. For example, a person may say “Hello, my name is . . . ”, “I am . . . ” or other similar ways of introducing oneself. If the speaker's intent is a self-introduction intent, then at a decision block 806, the name identification engine 640 may determine whether the entity data 634 represents a person name. As described above, the entity data 634 may include an entity name and a corresponding entity type. If the entity type associated with the entity name, as included in the entity data 634, is a person, then at a step 808, the name identification engine 640 may determine the speaker name 644 using the entity data 634. The name identification engine 640 may determine the speaker name 644 to be the entity name included in the entity data 634. In a non-limiting example, the sentence being processed may be “Hello, my name is Alex,” the NLP engine 630 may determine the intent data 632 to be “self-introduction intent” and the entity data 634 to be {entity name: “Alex”; entity type: person}. According to the routine 800, the name identification engine 640 may determine the speaker name to be “Alex” for the foregoing example sentence.

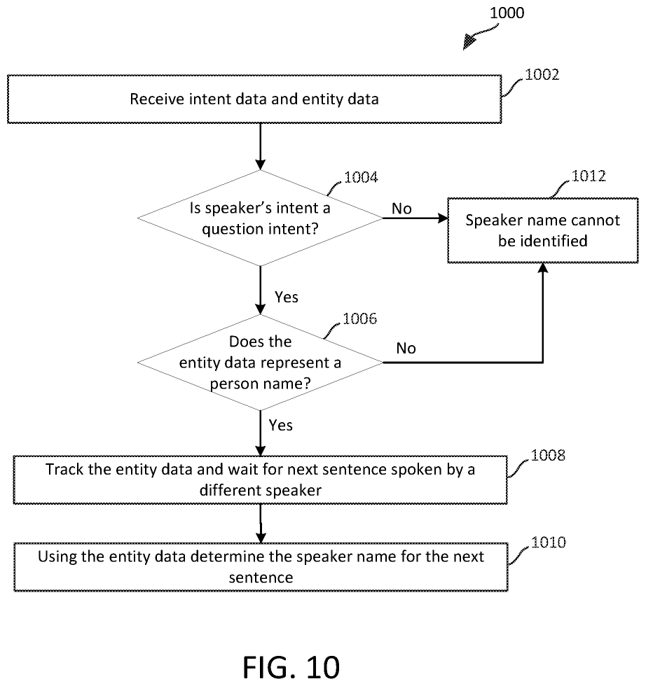

Referring to FIG. 8, at the decision block 804, if the name identification engine 640 determines that the speaker's intent is not a self-introduction intent, then at a step 810, the name identification engine 640 may determine that the speaker name cannot be identified. At the decision block 806, if the entity data does not represent a person name, then at a step 810, the name identification engine 640 may determine that the speaker name cannot be identified. Based on this determination at the step 810, the name identification engine 640 may use other routines (described below in relation to FIGS. 9-10) to determine the speaker name. In some implementations, the other routines may be run in parallel to determine the speaker name.

FIG. 9 shows a third example routine 900 that may be performed by the name identification engine 640 as part of the step 714 of the routine 700 shown in FIG. 7. At a step 902 of the routine 900, the name identification engine 640 may receive the intent data 632 and the entity data 634 from the NLP engine 630. At a decision block 904, the name identification engine 640 may determine whether the speaker's intent (included in the intent data 632) is an intent to introduce another. An intent to introduce another may be when a person introduces another person. For example, a person may say “I would like to introduce . . . ”, “Our next guest is . . . ”, “Here is our manager . . . ”, “On the call with me is . . . ”, or other similar ways of introducing another person. If the speaker's intent is an intent to introduce another, then at a decision block 906, the name identification engine 640 may determine whether the entity data 634 represents a person name. If the entity type associated with the entity name, as included in the entity data 634, is a person, then at a step 908, the name identification engine 640 may track the entity data 634 and wait for the next sentence (from the data 104) spoken by a different speaker. In some implementations, the name identification engine 640 may select the next sentence, from the data 104, associated with a speaker number that is different than the speaker number associated with the instant sentence. At a step 910, the name identification engine 640 may determine the speaker name 644 for the next sentence using the entity data 634. The name identification engine 640 may determine the speaker name 644 to be the entity name included in the entity data 634. In a non-limiting example, the instant sentence being processed may be “Let me introduce Alex,” where the sentence is associated with “speaker 1”, and the NLP engine 630 may determine the intent data 632 to be “intent to introduce another” and the entity data 634 to be {entity name: “Alex”; entity type: person}. According to the routine 900, the name identification engine 640 may select the next sentence associated with “speaker 2”, which may be “Hello, thank you for the introduction”, and may determine the speaker name for “speaker 2” to be “Alex” for the foregoing example sentence.

Referring to FIG. 9, at the decision block 904, if the name identification engine 640 determines that the speaker's intent is not an intent to introduce another, then at a step 912, the name identification engine 640 may determine that the speaker name cannot be identified. At the decision block 906, if the entity data does not represent a person name, then at a step 912, the name identification engine 640 may determine that the speaker name cannot be identified. Based on this determination at the step 912, the name identification engine 640 may use other routines (described herein in relation to FIGS. 8 and 10) to determine the speaker name 644. In some implementations, the other routines may be run in parallel to determine the speaker name 644.

FIG. 10 shows a fourth example routine 1000 that may be performed by the name identification engine 640 as part of the step 714 of the routine 700 shown in FIG. 7. At a step 1002 of the routine 1000, the name identification engine 640 may receive the intent data 632 and the entity data 634 from the NLP engine 630. At a decision block 1004, the name identification engine 640 may determine whether the speaker's intent (included in the intent data 632) is a question intent. A question intent may be when a person asks a question. For example, a person may say “Can I ask a question?”, “I have a question for . . . ”, “Joe, can you talk about . . . ?”, or other similar ways of asking a question. The question may or may not be directed to a particular person. If the speaker's intent is a question intent, then at a decision block 1006, the name identification engine 640 may determine whether the entity data 634 represents a person name. If the entity type associated with the entity name, as included in the entity data 634, is a person, then at a step 1008, the name identification engine 640 may store (e.g., track) the entity data 634 and wait for the next sentence (from the data 104) spoken by a different speaker. For example, the name identification engine 640 may store the entity data 634 along with an indication of which sentence/words the entity data 634 corresponds to. Such an indication may be the sentence (words) itself, a sentence identifier, an indication that the sentence is the immediately preceding sentence, etc. In some implementations, the name identification engine 640 may select the next sentence, from the data 104, associated with a speaker number that is different than the speaker number associated with the instant sentence. At a step 1010, the name identification engine 640 may determine the speaker name 644 for the next sentence using the entity data 634. The name identification engine 640 may determine the speaker name 644 to be the entity name included in the entity data 634. In some implementations, the name identification engine 640 (using the NLP engine 630) may determine whether the next sentence, spoken by a different speaker, is responsive to the instant sentence/question (e.g., the next sentence is associated with an answer intent), and based on this determination the name identification engine 640 may determine the speaker name 644 for the next sentence. In a non-limiting example, the instant sentence being processed may be “Alex, can you talk about the project?,” where the sentence is associated with “speaker 1”, and the NLP engine 630 may determine the intent data 632 to be “question intent” and the entity data 634 to be {entity name: “Alex”; entity type: person}. According to the routine 1000, the name identification engine 640 may select the next sentence associated with “speaker 2”, which may be “Yes, let me give a summary of the project”, and may determine the speaker name for “speaker 2” to be “Alex” for the foregoing example sentence.

Referring to FIG. 10, at the decision block 1004, if the name identification engine 640 determines that the speaker's intent is not an intent to introduce another, then at a step 1012, the name identification engine 640 may determine that the speaker name cannot be identified. At the decision block 1006, if the entity data does not represent a person name, then at a step 1012, the name identification engine 640 may determine that the speaker name cannot be identified. Based on this determination at the step 1012, the name identification engine 640 may use other routines (described herein in relation to FIGS. 8 and 9) to determine the speaker name 644. In some implementations, the other routines may be run in parallel to determine the speaker name 644.

Although FIGS. 8-10 show routines relating to determining a speaker name based on certain intents (e.g., self-introduction intent, an intent to introduce another, and a question intent), it should be understood that the name identification engine 640 may determine a speaker name based on other intents. In some implementations, the name identification engine 640 may determine a speaker name based on an instant sentence being associated with an intent to engage, and the sentence mentioning a particular person. The name identification engine 640 may determine the speaker name for the next sentence spoken by a different speaker based on the instant sentence. In a non-limiting example, the instant sentence being processed may be “Hi Joe. How are you?” where the sentence is associated with “speaker 1”, and the NLP engine 630 may determine the intent data 632 to be “intent to engage” and the entity data 634 to be {entity name: “Joe”; entity type: person}. The name identification engine 640 may select the next sentence associated with “speaker 2”, which may be “I am well”, and may determine the speaker name for “speaker 2” to be “Joe” for the foregoing example sentence. In another non-limiting example, an instant sentence being processed may be “Thank you Alex,” where the sentence is associated with “speaker 1.” The name identification engine 640 may store data identifying at least a sentence spoken prior to the instant sentence and associated with “speaker 2.” The NLP engine 630 may determine the intent data 632 for the instant sentence to be “intent to engage” and the entity data 634 to be {entity name: “Alex”; entity type: person}. Based on the instant sentence referring to “Alex” and the previous sentence being spoken by a different person, the name identification engine 640 may determine the speaker name for “speaker 2” to be “Alex.” In this non-limiting example, the NLP engine 630 may determine the intent for the instant sentence to be “intent to respond” or other similar meaning expressed by the speaker.

In some implementations, the speaker name identification system 100 may determine a speaker name based on determining that a particular speaker was interrupted. For example, a first sentence, associated with “speaker 1”, may be “Joe, can you please explain . . . ”, a second sentence, associated with “speaker 2”, may be “Joe, before you do, can I ask another question . . . ”, and a third sentence, associated with “speaker 3”, may be “Yes, I can talk about that . . . . ” The NLP engine 630 may determine that an intent of the first sentence is “intent to engage”, an intent of the second sentence is “intent to interrupt”, and an intent of the third sentence is “intent to respond.” Based on the sequence of the example sentences and the second sentence being an intent to interrupt, the name identification engine 640 may determine that the speaker name for “speaker 3” is “Joe,” rather than that being the speaker name for “speaker 2.” The name identification engine 640 may determine that even though the first sentence is requesting “Joe” to engage, the second sentence following the first sentence is not spoken by “Joe” but rather is an interruption by another speaker. In this case, the name identification engine 640 may identify the next/third sentence spoken by a different speaker and providing a response (e.g., having an intent to respond).

In some implementations, the name identification engine 640 may use one or more dialog flow models that may be configured to capture or simulate the routines 800, 900 and 1000 shown in FIGS. 8-10. For example, a first dialog flow model may be associated with an intent to introduce another, and may include various example first sentences that may relate to the intent to introduce another. The first dialog flow model may further include various example second sentences that may follow (be responsive to) the example first sentences. Based on an instant sentence, from the data 104, being associated with an intent to introduce another, the name identification engine 640 may compare the next sentence from the data 104, spoken by a different speaker, to the example second sentences to determine whether the next sentence is similar to what persons typically say in response to another person introducing them. Based on the next sentence being similar to one or more of the example second sentences in the dialog flow model, the name identification engine 640 may determine the speaker name, for the next sentence, as the person name included in the instant sentence. As another example, a second dialog flow model may be associated with a question intent, may include various example first sentences that may simulate different ways a person may ask a question, and may include various example second sentences that may simulate different ways a person may respond to a question.

In some implementations, the NLP engine 630 may be configured to filter certain intents before sending the intent data 632 to the name identification engine 640. The NLP engine 630 may be configured to identify only certain intents, such as, a self-introduction intent, an intent to introduce another, a question intent, an answer intent, and an intent to engage. The NLP engine 630 may be configured to identify other intents that may be used to identify speaker names. If the NLP engine 630 determines that a speaker's intent associated with the sentence is not one of the intents, then the NLP engine 630 may output a “null” value for the intent data 632 or may output an “other” intent (or other similar indications) to inform the name identification engine 640 that the sentence cannot be used to determine a speaker name.

Similarly, in some implementations, the NLP engine 630 may be configured to filter certain entities before sending the entity data 634 to the name identification engine 640. The NLP engine 630 may be configured to identify only certain entity types, such as, a person entity type. The NLP engine 630 may be configured to identify other entity types that may be used to identify speaker names or that may be used to identify information corresponding to the speakers. If the NLP engine 630 determines that the entity mentioned in the sentence is not one of the entity types, then the NLP engine 630 may output a “null” value for the entity data 634 or may output an “other” entity type (or other similar indications) to inform the name identification engine 640 that the sentence cannot be used to determine a speaker name.

In some implementations, the speaker name identification system 100 may use techniques similar to the ones described herein to determine information associated with a particular speaker. In some circumstances, one or more persons may provide information about themselves during a meeting (or other settings) captured in an audio (or video) recording. Such information may include an organization name (e.g., a company the person works for, an organization the person represents or is associated with, etc.), a job title or role for the person (e.g., manager, supervisor, head-engineer, etc.), a team name that the person is associated with, a location of the person (e.g., an office location, a location from where the person is speaking, etc.), and other information related to the person. The speaker name identification system 100 may use the NLP engine 630 to determine entity data associated with a sentence and relating to such information. The name identification engine 640 may associate the foregoing entity data with the speaker name determined for the sentence. For example, a person may say “Hi my name is Alex. I am the lead engineer on the project in the Boston office.” Based on processing this example sentence, the speaker name identification system 100 may determine that the speaker name associated with this sentence is “Alex”, and may determine that the speaker's role is “lead engineer” and the speaker's location is “Boston.” The speaker name identification system 100 may output an indication of the speaker's role and speaker's location (any other determined information) along with the speaker name. Such indication may be inserted in the transcript included in the data 104, or may be inserted in or associated with the audio or video file provided by the user 102.

In this manner, the speaker name identification system 100 may determine a speaker name from data representing words spoken by multiple persons. The speaker name identification system 100 may use a speaker's intent and person names mentioned by a speaker to determine the speaker name.

### G. Example Implementations of Methods, Systems, and Computer-Readable Media in Accordance with the Present Disclosure

The following paragraphs (M1) through (M9) describe examples of methods that may be implemented in accordance with the present disclosure.

(M1) A method may involve receiving, by a computing system, data representing dialog between persons, the data representing words spoken by at least first and second speakers, determining, by the computing system, an intent of a speaker for a first portion of the data, the intent being indicative of an identity of the first or second speaker for the first portion of the data or another portion of the data different than the first portion, determining, by the computing system, a name of the first or second speaker represented in the first portion of the data based at least in part on the determined intent, and outputting, by the computing system, an indication of the determined name so that the indication identifies the first portion of the data or the another portion of the data with the first or second speaker.

(M2) A method may be performed as described in paragraph (M1), and may further involve determining, by the computing system, that the first portion of the data represents a first sentence spoken by the first speaker, determining, by the computing system, that the intent of a speaker for the first portion of the data is a self-introduction intent, and determining the name of the first speaker based at least in part on the determined intent being the self-introduction intent and the first sentence having been spoken by the first speaker.

(M3) A method may be performed as described in paragraph (M1) or paragraph (M2), and may further involve determining, by the computing system, that the first portion of the data represents a first sentence, determining, by the computing system, that the intent of a speaker for the first portion of the data is an intent to introduce another person, determining, by the computing system, that the another portion of the data represents a second sentence spoken by the second speaker, determining, by the computing system, that the second sentence follows the first sentence, and determining the name of the second speaker based at least in part on the determined intent being an intent to introduce another person, the second sentence having been spoken by the second speaker, and the second sentence following the first sentence.

(M4) A method may be performed as described in any of paragraphs (M1) through (M3), and may further involve determining, by the computing system, that the first portion of the data represents a first sentence, determining, by the computing system, that the intent of a speaker for the first portion of the data is a question intent, determining, by the computing system, that the another portion of the data represents a second sentence spoken by the second speaker, determining, by the computing system, that the second sentence follows the first sentence, and determining the name of the second speaker based at least in part on the determined intent being an question intent, the second sentence having been spoken by the second speaker, and the second sentence following the first sentence.

(M5) A method may be performed as described in any of paragraphs (M1) through (M4), and may further involve receiving, by the computing system, an audio file, and performing, by the computing system, speech recognition processing on the audio file to determine the data dialog between persons.

(M6) A method may be performed as described in paragraph (M5), and may further involve identifying, using the data, a portion of the audio file corresponding to first words spoken by the first speaker, identifying the name of the first speaker, and associating, in the audio file, the indication with the portion of the audio file.

(M7) A method may be performed as described in any of paragraphs (M1) through (M6), and may further involve updating the data to include the indication.

(M8) A method may be performed as described in any of paragraphs (M1) through (M7), and may further involve processing the first portion of the data using a natural language processing (NLP) technique to determine the intent of a speaker and the name represented in the first portion of the data.

(M9) A method may be performed as described in any of paragraphs (M1) through (M8), and may further involve processing the data to determine information associated with the first or second speaker.

The following paragraphs (S1) through (S9) describe examples of systems and devices that may be implemented in accordance with the present disclosure.

(S1) A computing system may comprise at least one processor and at least one computer-readable medium encoded with instructions which, when executed by the at least one processor, cause the computing system to receive data representing dialog between persons, the data representing words spoken by at least first and second speakers, determine an intent of a speaker for a first portion of the data, the intent being indicative of an identity of the first or second speaker for the first portion of the data or another portion of the data different than the first portion, determine a name of the first or second speaker represented in the first portion of the data based at least in part on the determined intent, and output an indication of the determined name so that the indication identifies the first portion of the data or the another portion of the data with the first or second speaker.

(S2) A computing system may be configured as described in paragraph (S1), and the at least one computer-readable medium may be encoded with additional instructions which, when executed by the at least one processor, further cause the computing system to determine that the first portion of the data represents a first sentence spoken by the first speaker, determine that the intent of a speaker for the first portion of the data is a self-introduction intent, and determine the name of the first speaker based at least in part on the determined intent being the self-introduction intent and the first sentence having been spoken by the first speaker.

(S3) A computing system may be configured as described in paragraph (S1) or paragraph (S2), and the at least one computer-readable medium may be encoded with additional instructions which, when executed by the at least one processor, further cause the computing system to determine that the first portion of the data represents a first sentence, determine that the intent of a speaker for the first portion of the data is an intent to introduce another person, determine that the another portion of the data represents a second sentence spoken by the second speaker, determine that the second sentence follows the first sentence, and determine the name of the second speaker based at least in part on the determined intent being an intent to introduce another person, the second sentence having been spoken by the second speaker, and the second sentence following the first sentence.

(S4) A computing system may be configured as described in any of paragraphs (S1) through paragraph (S3), and the at least one computer-readable medium may be encoded with additional instructions which, when executed by the at least one processor, further cause the computing system to determine that the first portion of the data represents a first sentence, determine that the intent of a speaker for the first portion of the data is a question intent, determine that a second portion of the data represents a second sentence spoken by the second speaker, determine that the second sentence follows the first sentence, and determine the name of the second speaker based at least in part on the determined intent being an question intent, the second sentence having been spoken by the second speaker, and the second sentence following the first sentence.

(S5) A computing system may be configured as described in any of paragraphs (S1) through (S4), and the at least one computer-readable medium may be encoded with additional instructions which, when executed by the at least one processor, further cause the computing system to receive an audio file, and perform speech recognition processing on the audio file to determine the data representing dialog between persons.

(S6) A computing system may be configured as described in paragraph (S5), and the at least one computer-readable medium may be encoded with additional instructions which, when executed by the at least one processor, further cause the computing system to identify, using the data, a portion of the audio file corresponding to first words, identify the name of the first speaker, and associate, in the audio file, the indication with the portion of the audio file.

(S7) A computing system may be configured as described in any of paragraphs (S1) through (S6), and the at least one computer-readable medium may be encoded with additional instructions which, when executed by the at least one processor, further cause the computing system to update the data to include the indication.

(S8) A computing system may be configured as described in any of paragraphs (S1) through (S7), and the at least one computer-readable medium may be encoded with additional instructions which, when executed by the at least one processor, further cause the computing system to process the first portion of the data using a natural language processing (NLP) technique to determine the intent of a speaker and the name represented in the first portion of the data.

(S9) A computing system may be configured as described in any of paragraphs (S1) through (S8), and the at least one computer-readable medium may be encoded with additional instructions which, when executed by the at least one processor, further cause the computing system to processing the data to determine information associated with the first or second speaker.

The following paragraphs (CRM1) through (CRM9) describe examples of computer-readable media that may be implemented in accordance with the present disclosure.

(CRM1) At least one non-transitory computer-readable medium may be encoded with instructions which, when executed by at least one processor of a computing system, cause the computing system to receive data representing dialog between persons, the data representing words spoken by at least first and second speakers, determine an intent of a speaker for a first portion of the data, the intent being indicative of an identity of the first or second speaker for the first portion of the data or another portion of the data different than the first portion, determine a name of the first or second speaker represented in the first portion of the data based at least in part on the determined intent, and output an indication of the determined name so that the indication identifies the first portion of the data or the another portion of the data with the first or second speaker.

(CRM2) At least one non-transitory computer-readable medium may be configured as described in paragraph (CRM1), and may be encoded with additional instruction which, when executed by the at least one processor, further cause the computing system to determine that the first portion of the data represents a first sentence spoken by the first speaker, determine that the intent of a speaker for the first portion of the data is a self-introduction intent, and determine the name of first speaker based at least in part on the determined intent being the self-introduction intent and the first sentence having been spoken by the first speaker.

(CRM3) At least one non-transitory computer-readable medium may be configured as described in paragraph (CRM1) or paragraph (CRM2), and may be encoded with additional instruction which, when executed by the at least one processor, further cause the computing system to determine that the first portion of the data represents a first sentence, determine that the intent of a speaker for the first portion of the data is an intent to introduce another person, determine that a second portion of the data represents a second sentence spoken by the second speaker, determine that the second sentence follows the first sentence, and determine the name of the second speaker based at least in part on the determined intent being an intent to introduce another person, the second sentence having been spoken by the second speaker, and the second sentence following the first sentence.

(CRM4) At least one non-transitory computer-readable medium may be configured as described in any of paragraphs (CRM1) through (CRM3), wherein the first file is to be shared with a second user, and may be encoded with additional instruction which, when executed by the at least one processor, further cause the computing system to determine that the first portion of the data represents a first sentence, determine that the intent of a speaker for the first portion of the data is a question intent, determine that a second portion of the data represents a second sentence spoken by the second speaker, determine that the second sentence follows the first sentence, and determine the name of the second speaker based at least in part on the determined intent being an question intent, the second sentence having been spoken by the second speaker, and the second sentence following the first sentence.

(CRM5) At least one non-transitory computer-readable medium may be configured as described in any of paragraphs (CRM1) through (CRM4), and may be encoded with additional instruction which, when executed by the at least one processor, further cause the computing system to receive an audio file, and perform speech recognition processing on the audio file to determine the data representing dialog between persons.

(CRM6) At least one non-transitory computer-readable medium may be configured as described in paragraph (CRM5), and may be encoded with additional instruction which, when executed by the at least one processor, further cause the computing system to identify, using the data, a portion of the audio file corresponding to first words, identify the name of the first speaker, and associate, in the audio file, the indication with the portion of the audio file.

(CRM7) At least one non-transitory computer-readable medium may be configured as described in any of paragraphs (CRM1) through (CRM6), and may be encoded with additional instruction which, when executed by the at least one processor, further cause the computing system to update the data to include the indication.

(CRM8) At least one non-transitory computer-readable medium may be configured as described in any of paragraphs (CRM1) through (CRM7), and may be encoded with additional instruction which, when executed by the at least one processor, further cause the computing system to process the first portion of the data using a natural language processing (NLP) technique to determine the intent of a speaker and the name represented in the first portion of the data.

(CRM9) At least one non-transitory computer-readable medium may be configured as described in any of paragraphs (CRM1) through (CRM8), and may be encoded with additional instruction which, when executed by the at least one processor, further cause the computing system to processing the data to determine information associated with the first or second speaker.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method comprising:
receiving, by a computing system, data representing dialog between persons, the data representing words spoken by at least first and second speakers;
determining, by the computing system, an intent of a speaker for a first portion of the data, the intent being indicative of an identity of the first or second speaker for the first portion of the data or another portion of the data different than the first portion;
determining, by the computing system, a name of the first or second speaker represented in the first portion of the data based at least in part on the determined intent; and
outputting, by the computing system, an indication of the determined name so that the indication identifies the first portion of the data or the another portion of the data with the first or second speaker.

2. The method of claim 1, further comprising:
determining, by the computing system, that the first portion of the data represents a first sentence spoken by the first speaker;
determining, by the computing system, that the intent of a speaker for the first portion of the data is a self-introduction intent; and
determining the name of the first speaker based at least in part on the determined intent being the self-introduction intent and the first sentence having been spoken by the first speaker.

3. The method of claim 1, further comprising:
determining, by the computing system, that the first portion of the data represents a first sentence;
determining, by the computing system, that the intent of a speaker for the first portion of the data is an intent to introduce another person;
determining, by the computing system, that the another portion of the data represents a second sentence spoken by the second speaker;
determining, by the computing system, that the second sentence follows the first sentence; and
determining the name of the second speaker based at least in part on the determined intent being an intent to introduce another person, the second sentence having been spoken by the second speaker, and the second sentence following the first sentence.

4. The method of claim 1, further comprising:
determining, by the computing system, that the first portion of the data represents a first sentence;
determining, by the computing system, that the intent of a speaker for the first portion of the data is a question intent;
determining, by the computing system, that the another portion of the data represents a second sentence spoken by the second speaker;
determining, by the computing system, that the second sentence follows the first sentence; and
determining the name of the second speaker based at least in part on the determined intent being an question intent, the second sentence having been spoken by the second speaker, and the second sentence following the first sentence.

5. The method of claim 1, further comprising:
receiving, by the computing system, an audio file; and
performing, by the computing system, speech recognition processing on the audio file to determine the data representing dialog between persons.

6. The method of claim 5, further comprising:
identifying, using the data, a portion of the audio file corresponding to first words spoken by the first speaker;
identifying the name of the first speaker; and
associating, in the audio file, the indication with the portion of the audio file.

7. The method of claim 1, further comprising:
updating the data to include the indication.

8. The method of claim 1, further comprising:
processing the first portion of the data using a natural language processing (NLP) technique to determine the intent of a speaker and the name represented in the first portion of the data.

9. The method of claim 1, further comprising:
processing the data to determine information associated with the first or second speaker.

10. A computing system comprising:
at least one processor; and
at least one computer-readable medium encoded with instructions which, when executed by the at least one processor, cause the computing system to:
receive data representing dialog between persons, the data representing words spoken by at least first and second speakers;
determine an intent of a speaker for a first portion of the data, the intent being indicative of an identity of the first or second speaker for the first portion of the data or another portion of the data different than the first portion;
determine a name of the first or second speaker represented in the first portion of the data based at least in part on the determined intent; and
output an indication of the determined name so that the indication identifies the first portion of the data or the another portion of the data with the first or second speaker.

11. The computing system of claim 10, wherein the at least one computer-readable medium is encoded with additional instructions which, when executed by the at least one processor, further cause the computing system to:
determine that the first portion of the data represents a first sentence spoken by the first speaker;
determine that the intent of a speaker for the first portion of the data is a self-introduction intent; and
determine the name of the first speaker based at least in part on the determined intent being the self-introduction intent and the first sentence having been spoken by the first speaker.

12. The computing system of claim 10, wherein the at least one computer-readable medium is encoded with additional instructions which, when executed by the at least one processor, further cause the computing system to:
determine that the first portion of the data represents a first sentence;
determine that the intent of a speaker for the first portion of the data is an intent to introduce another person;
determine that the another portion of the data represents a second sentence spoken by the second speaker;
determine that the second sentence follows the first sentence;
determine the name of the second speaker based at least in part on the determined intent being an intent to introduce another person, the second sentence having been spoken by the second speaker, and the second sentence following the first sentence.

13. The computing system of claim 10, wherein the at least one computer-readable medium is encoded with additional instructions which, when executed by the at least one processor, further cause the computing system to:
determine that the first portion of the data represents a first sentence;
determine that the intent of a speaker for the first portion of the data is a question intent;
determine that the another portion of the data represents a second sentence spoken by the second speaker;
determine that the second sentence follows the first sentence; and
determine the name of the second speaker based at least in part on the determined intent being an question intent, the second sentence having been spoken by the second speaker, and the second sentence following the first sentence.

14. The computing system of claim 10, wherein the at least one computer-readable medium is encoded with additional instructions which, when executed by the at least one processor, further cause the computing system to:
receive an audio file; and
perform speech recognition processing on the audio file to determine the data representing dialog between persons.

15. The computing system of claim 14, wherein the at least one computer-readable medium is encoded with additional instructions which, when executed by the at least one processor, further cause the computing system to:
identify, using the data, a portion of the audio file corresponding to first words spoken by the first speaker;
identify the name of the first speaker; and
associate, in the audio file, the indication with the portion of the audio file.

16. The computing system of claim 10, wherein the at least one computer-readable medium is encoded with additional instructions which, when executed by the at least one processor, further cause the computing system to:
update the data to include the indication.

17. The computing system of claim 10, wherein the at least one computer-readable medium is encoded with additional instructions which, when executed by the at least one processor, further cause the computing system to:
process the first portion of the data using a natural language processing (NLP) technique to determine the intent of a speaker and the name represented in the first portion of the data.

18. The computing system of claim 10, wherein the at least one computer-readable medium is encoded with additional instructions which, when executed by the at least one processor, further cause the computing system to:
process the data to determine information associated with the first or second speaker.

19. At least one non-transitory computer-readable medium encoded with instructions which, when executed by at least one processor of a computing system, cause the computing system to:
receive data representing dialog between persons, the data representing words spoken by at least first and second speakers;
determine an intent of a speaker for a first portion of the data, the intent being indicative of an identity of the first or second speaker for the first portion of the data or another portion of the data different than the first portion;
determine a name of the first or second speaker represented in the first portion of the data based at least in part on the determined intent; and
output an indication of the determined name so that the indication identifies the first portion of the data or the another portion of the data with the first or second speaker.

20. The at least one non-transitory computer-readable medium of claim 19, further encoded with additional instructions which, when executed by the at least one processor, cause the computing system to:
determine that the first portion of the data represents a first sentence spoken by the first speaker;
determine that the intent of a speaker for the first portion of the data is a self-introduction intent; and
determine the name of first speaker based at least in part on the intent being the self-introduction intent and the first sentence having been spoken by the first speaker.
